(19) United States
(12) Patent Application Publication
(10) Pub. No.: US 2026/0127552 A1
(43) Pub. Date: May 7, 2026

(54) VISUAL INDICATORS REPRESENTING FOLDER MEMBERSHIP OF EMAIL MESSAGES

(71) Applicant: Mark Lambert, Tarpon Springs, FL (US)

(72) Inventor: Mark Lambert, Tarpon Springs, FL (US)

(21) Appl. No.: 18/936,861

(22) Filed: Nov. 4, 2024

(51) Int. Cl. G06Q 10/107; G06F 16/16; H04L 51/42

(52) U.S. Cl. CPC G06Q 10/107; G06F 16/168; H04L 51/42

(57) ABSTRACT

The disclosed system obtains multiple groups of messages, where a first group of messages among the multiple groups of messages includes a first multiplicity of messages and where a second group of messages among the multiple groups of messages includes a second multiplicity of messages, different from the first multiplicity of messages. The system determines a first visual indicator associated with the first group of messages and a second visual indicator associated with the second group of messages, different from the first visual indicator. The first and the second visual indicators indicate membership in the first and second group of messages, respectively. The system applies the first visual indicator to the first group of messages and the second visual indicator to the second group of messages, thereby indicating to a user a grouping of the first multiplicity of messages and the second multiplicity of messages.

### BACKGROUND

Electronic mail (email or e-mail) is a method of transmitting and receiving messages using electronic devices. Email is a ubiquitous and very widely used communication medium. Email operates across computer networks, primarily the Internet, and also local area networks. Today's email systems are based on a store-and-forward model. Email servers accept, forward, deliver, and store messages. Neither the users nor their computers are required to be online simultaneously; they need to connect, typically, to a mail server or a webmail interface to send or receive messages or download them. Originally an ASCII text-only communications medium, Internet email was extended by Multipurpose Internet Mail Extensions (MIME) to carry text in other character sets and multimedia content attachments. Usually, the mail is organized in folders in the mail server, and the folders are presented to the user. When the folders become numerous, it may be difficult for the user interacting with a single email to understand to what folder the email belongs.

### BRIEF DESCRIPTION OF THE DRAWINGS

Detailed descriptions of implementations of the present invention will be described and explained through the use of the accompanying drawings.

FIG. 1 shows an email inbox including visual indicators representing folder membership.

FIG. 2 shows visual indicators representing a location of a folder in a hierarchy of messages.

FIG. 3 shows how changing the location of a folder in the hierarchy changes the folder's visual indicator.

FIG. 4 is a flowchart of a method to create visual indicators representing folder membership of email messages, according to one embodiment.

FIG. 5 shows multiple hierarchies of folders.

FIG. 6 is a flowchart of a method to create visual indicators representing folder membership of email messages, according to another embodiment.

FIG. 7 is a block diagram of an example transformer.

FIG. 8 is a block diagram that illustrates an example of a computer system 800 in which at least some operations described herein can be implemented.

FIG. 9 illustrates a user engaged with a mixed reality system for immersive message management.

FIG. 10 is a block diagram illustrating a cloud stack and a client stack architecture for a platform that can collectively administer a mixed reality session on a head-mounted display (HMD) device.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology is directed to an enhanced email system that improves user navigation and organization within email clients. The disclosed system can associate various visual indicators, individually or in combination, such as font size, font style, text color, or symbols (e.g., images, icons, stars, pound signs), with folders containing email, thus helping the user distinguish folders from each other. This differentiation helps users quickly identify a specific folder amidst numerous other folders, reducing the likelihood of confusion and misfiling. Additionally, when the folder containing the visual indicator is expanded to display its contents, the emails within the folder are also marked with similar visual indicators, ensuring that users are constantly aware that they are viewing related emails.

One such labeled folder can be the archive folder. Creating a visual indication for the archive folder is particularly useful when emails are automatically archived after a certain period. The visual indication helps users avoid mistakenly interacting with archived emails as if they were current or current emails that could mistakenly be filed in an open archive folder.

As mentioned above, the disclosed technology is applicable to any folder or subfolder containing email messages, not just the archive folder. Any folder created by the user, such as project-specific folders, can be visually distinguished using the same set of indicators. For example, a folder named “Project X” could be displayed in a red font, making it easily identifiable for filing or retrieving emails. The disclosed system enhances overall email management by providing a clear and intuitive way to navigate through various folders and their contents, thereby improving efficiency and reducing the risk of errors in email handling.

### Visual Indicators Representing Folder Membership of Email Messages

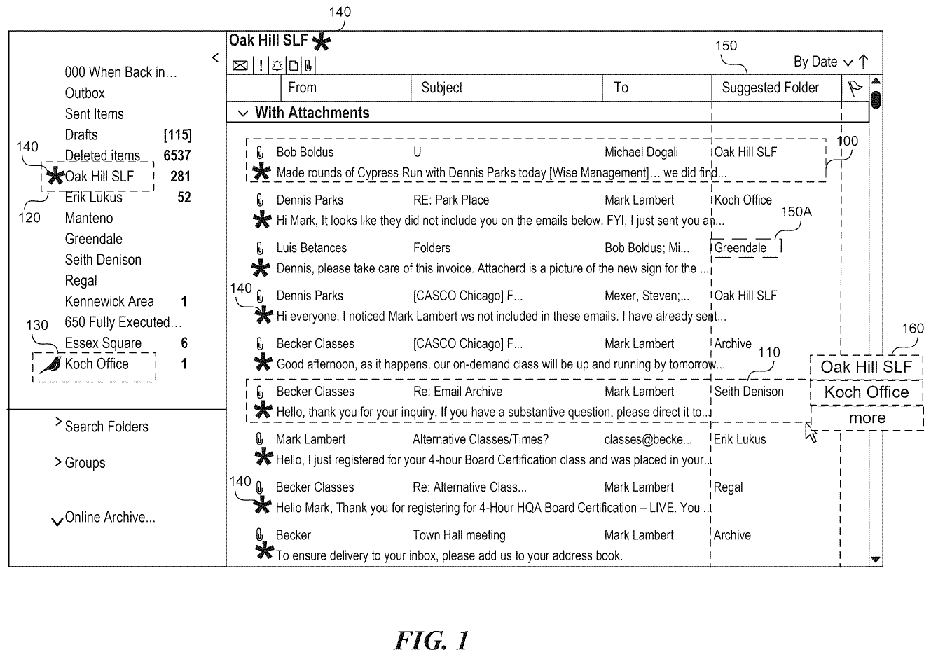

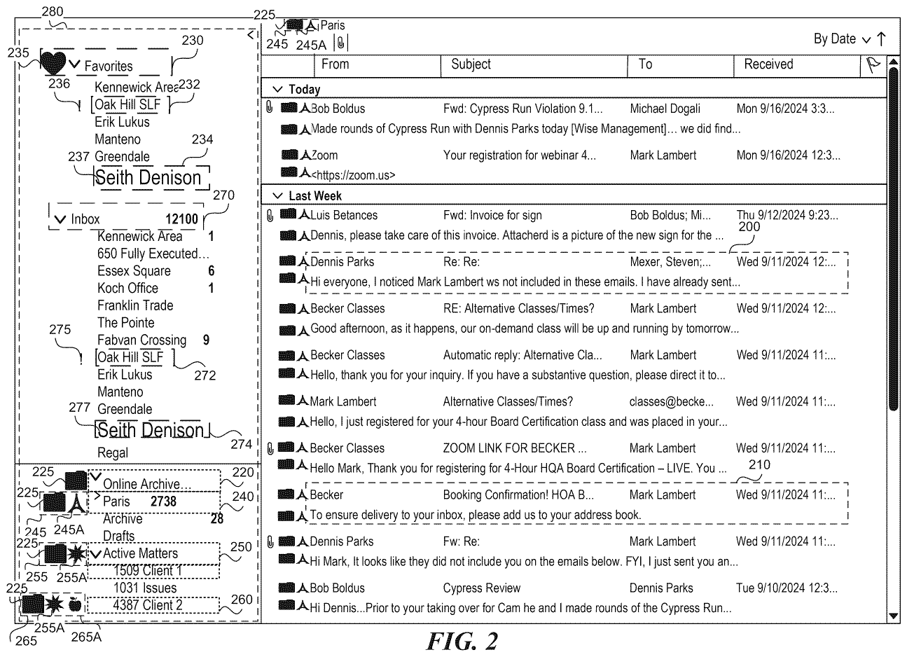

FIG. 1 shows an email inbox including visual indicators representing folder membership. Email messages 100, 110 (only two labeled for brevity) currently reside in folder 120 in an Inbox, but can be moved or copied into another folder 130 (only two folders labeled for brevity). The multiple folders 120, 130 can include one or more visual indicators 140 to represent folder membership of the email messages 100, 110. For example, if one visual indicator is “*” and the other visual indicator includes the color red, the one or more visual indicators 140 can include a red asterisk. In another example, if one visual indicator is a particular style of font and the other visual indicator is a particular size of font, the one or more visual indicators 140 can include the particular style of font in the particular size of font. In a third example, visual indicators 140 can be concatenated as shown in FIG. 2.

The visual indicator 140 can include a color code, a font style, and/or a symbol, such as a star, a pound sign, an icon, a pictograph, etc. The visual indicator 140 can be assigned to a single folder 120, and the same visual indicator 140 can be applied to each email message 100, 110 in the folder, thus indicating the folder membership of each email message 100, 110.

The multiple folders 120, 130 can be created by the user to help organize an inbox or can be created by an artificial intelligence (AI) as described in this application. The AI can be prompted by the user to analyze the inbox, or the AI can periodically analyze the inbox, such as every day or every week. Based on the analysis of the content of the email messages 100, 110, the AI can determine grouping of the email messages 100, 110. For example, the AI can suggest moving the email messages 100, 110 to an existing folder 130, or the AI can suggest the creation of a new folder. The folders can indicate a common topic among the email messages or a common timeframe. For example, a common topic can be emails pertaining to a particular geographic location, a particular client, a particular project, a particular task, etc. In another example, a common timeframe can include all messages received within a particular month. Similarly, an archive folder can indicate a common timeframe and include all the messages that are older than a predetermined threshold, such as a year or 6 months.

In another embodiment, when a user is in the process of filing an email message 100, 110, the AI can suggest one or more possible folders 120, 130 to select from. Even if a user was not ready to file an email message 100, 110, the AI could show its suggestion in the column 150. In one example, to accept the suggestion, the user can then just select the suggestion 150A. In another example, instead of the AI showing the suggestions in the column 150, the user can hover over the email message 100, 110 and the suggested folders appear in the menu 160. If the suggestions in column 150 or menu 160 still are not acceptable, then the user can ask for more suggestions through menu items 155, 165.

The user can interact with the AI using natural language audio, e.g., by speaking to the AI and specifying the email message 100, 110 and the folder 120, 130 to which the email message should be moved. Upon receiving the natural language audio from the user, if the AI agrees with placing the email message 100, 110 in the folder 120, 130 as instructed in the natural language audio, the AI can perform the action. However, if the folder 120, 130 requested by the user is different from the AI suggested folder, the AI can ask for confirmation or the AI can suggest other folders verbally and/or visually. For example, if a user points to an email message 100, 110 and says, “Move to trash,” the AI can ask for confirmation. Similarly to the above, if the AI suggestions are not acceptable, then the user can ask for more suggestions. Upon a verbal command, the AI can create requested indicators. For example, the verbal command can say, “Indicate Patent Ideas folder with a star.” If a star is already being used for another folder, the AI can suggest alternative unique indicators.

If a new email message arrives on a new subject that does not have a folder assigned, the AI can suggest that a new folder be created, suggest a name of the folder, ask if a corresponding favorites folder should be created, and then file the emails with approval. The AI can suggest creating additional folders based on various criteria such as sender, date, or attachments.

The visual indicator 140 can be specified by a user to easily distinguish the folder 120 from other folders 130, or the visual indicator can be suggested by an AI. For example, upon suggesting a new folder to create, the AI can also suggest an icon for the new folder that can be indicative of the contents of the folder. In a specific example, if the folder includes messages for a particular geographic location, the AI can suggest a thumbnail image of the geographic location as the visual indicator 140 for the new folder. In another specific example, if the folder includes messages from a particular sender, the AI can suggest a thumbnail image of the sender as the visual indicator 140. In yet another specific example, the AI can retrieve an image sent as an attachment in one or more emails included in the folder and can create a thumbnail of the image as a representation of the folder. When suggesting the visual indicator 140, the AI ensures that the visual indicator 140 is unique and different from all the other visual indicators used in the inbox.

A single email message 100 can be included in multiple folders 120, 130. The visual indicator 140 associated with the email message 100 can change depending on the folder 120, 130. For example, if the email message 100 is displayed in the folder 120, and the visual indicator 140 of the folder 120 is green, the email message can be highlighted in green or can be presented in green font. If the same email message 100 is displayed in the folder 130, and the visual indicator 140 of the folder 130 is a pictograph of a bird, the email message can be shown with the bird pictograph next to it and without the green color coding.

FIG. 2 shows visual indicators representing a location of a folder in a hierarchy of messages. Messages 200, 210 (only two labeled for brevity) can be email messages, text messages, instant messages, or any messages that can be grouped. The messages 200, 210 can belong to folders 220, 230, 240, 250, 260, 270 (only six labeled for brevity). The folders 220, 230, 240, 250, 260, 270 can be organized in a hierarchy 280, akin to a directory structure, indicating folders. A folder can be a parent folder or a child folder which is nested under at least one parent folder.

The top-level folders can be folder 220 representing an online archive, folder 230 representing favorites, or inbox folder 270. The folder 220 can include child folders such as a Paris folder 240 and an Active Matters folder 250. The Active Matters folder 250 further includes child folders client 1, client 2 260, etc. Each folder 220, 230, 232, 240, 250, 260, 270, 272 can have a corresponding unique visual indicator 225, 235, 236, 245, 255, 265, 275. In addition, the visual indicators 245, 255, 265 can be compounded to indicate the location of the corresponding folder in the hierarchy 280 of folders.

For example, the visual indicator 245 can include the visual indicator 225 of the parent folder 220 and a visual indicator 245A that is unique to the folder 240. Similarly, the visual indicator 265 can include the visual indicator 225 of the parent folder 220, the visual indicator 255A of the parent folder 250, and a visual indicator 265A unique to the folder 260.

The folder 220 can be an archive folder which includes messages 200, 210 after a predetermined passage of time since the receipt of the messages 200, 210. For example, if the messages 200, 210 are older than 6 months, the system can automatically move the messages 200, 210 to the folder 220.

To determine the child folder 240, 250, 260 to which to move the message 200, 210, the system can use the hierarchy 280 of folders. For example, if the system is moving the message 200, 210 from the folder 230 to the folder 220, and the system can determine that the location of the message 200, 210 in the hierarchy 280 is “Favorites->Paris->2018,” the system can remove the top-level folder 230 to obtain “Paris->2018.” The system can then determine whether the folder 220 includes a “Paris->2018” child folder. If there is such a child folder, the system can move the message 200, 210 to the corresponding child folder under the parent folder 220. If there is no such folder, the system can move the message to the folder 220.

The favorites folder 230 can be a subset of the inbox folder 270 and can contain child folders 232, 234 (only two labeled for brevity) that the user accesses frequently. The child folders 232, 234 can have corresponding duplicate folders 272, 274 (only two labeled for brevity) in the inbox folder 270. If the user does not access a child folder 232, 234 in the favorites folder 230 within a predetermined amount of time, such as 6 months, the system can automatically remove the child folder 232, 234 from the favorites folder 230. The corresponding duplicate folder 272, 274 can remain in the inbox folder 270.

As opposed to typical alphabetical order, the system can arrange the folders 220, 230, 240, 250, 260, 270 by usage as described above or by the number of emails each folder contains. The system can arrange the emails within any given folder 220, 230, 240, 250, 260, 270 by criteria such as by importance so that the most important emails appear on top, by senders, by attachments, or by subject matter.

Not all folders 220, 230, 232, 240, 250, 260, 270, 272 must have a visual indicator 225, 235, 236, 245, 255, 265, 275. As shown in FIG. 2, the inbox folder 270 may lack a visual indicator. A user can indicate to the system which folders lack the visual indicator. In addition, sometimes not all of the hierarchical visual indicators 225, 255A are included when showing the visual indicators for a folder. For example, for folder 260, only the visual indicators 225 and 265A are included.

The favorites folder 230 can inherit the same visual indicator(s) 236, 237 from the corresponding visual indicators 275, 277 in the inbox folder 270 as shown in FIG. 2. The visual indicators 237, 277 can be the increased size of the font. When a new email arrives at the inbox folder 270, the system can file the email in a folder within the inbox folder or in another folder outside of the inbox folder such as the favorites folder 230. The email would then inherit the same visual indicator(s), if any, as the folder in which it was placed. For example, if the email was placed in the inbox folder 270, not in a child folder, the system does not add a visual indicator because the inbox folder 270 does not have a visual indicator. However, if the system placed the email in the favorites folder 230, not in a child folder, the system can add the visual indicator 235 to the newly added email.

As shown in FIG. 2, when a given folder 240 is open, the system can display the name of the folder 240, e.g., “Paris,” at the top of the disclosed email list. Next to the name, e.g., “Paris,” the system can display the visual indicators 225, 245A that are associated with the folder 240.

If the system copies and pastes an email into another folder(s), the system can show the indicators from all folders in which the email is duplicated. In other words, not only can the system show the hierarchical indicator 245 of the parent folder 240 next to each message 200, 210, but the system can also show the hierarchical indicator of the duplicate message (which is not shown in FIG. 2). For example, if message 200 in FIG. 2 was also located in the favorites folder 230, the system would show the favorites folder visual indicator 235, next to the hierarchical indicator 245.

If the system moves a message 200, 210 that is already filed in a folder 240 to a different folder 260, then the system removes the current visual indicator 245 and assigns the visual indicator 265 of the destination folder 260.

In all the above situations, the user is allowed to alter the default rules. For example, the user can specify to not show the file indicator(s) of the emails themselves, or to not automatically inherit the visual indicator from folders higher in the hierarchy 280.

The system can automatically indicate, using indicators, those folders that have the most recent activity. The indicator can resemble a clock with hands, where noon indicates the most recently updated folder and the hand position before noon indicates last recently updated folders. The system can show the top five most recent folders over the past 24 or 48 hours. Additionally, the system can indicate the number of messages each folder contains.

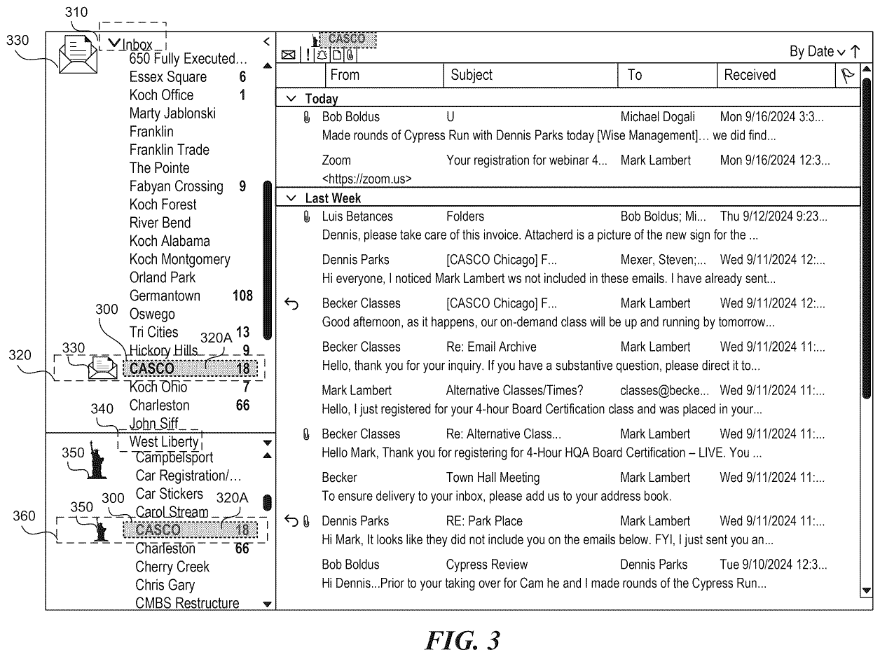

FIG. 3 shows how changing the location of a folder in the hierarchy changes the folder's visual indicator. Folder 300 can be located under the parent folder 310, inbox. In the parent folder 310, the folder 300 can have a visual indicator 320 including the color green 320A as well as the visual indicator 330 of the parent folder 310. When the folder 300 is moved to a new parent folder 340, the folder 300 can obtain a new visual indicator 360. The new visual indicator 360 can include the color green 320A and add the visual indicator 350 of the new parent folder 340.

As explained in this application, a folder can be shown twice, once in Inbox and once in Favorites. Such a folder can have the same visual indicators in both locations. However, the user can override the default rules and can change the visual indicators of a duplicated folder.

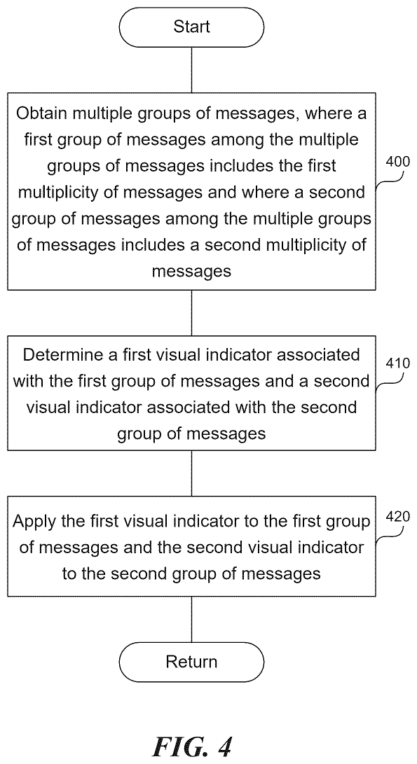

FIG. 4 is a flowchart of a method to create visual indicators representing folder membership of email messages, according to one embodiment. A hardware or software processor executing instructions describing this application can in step 400 obtain multiple groups of messages, where a first group of messages among the multiple groups of messages includes a first multiplicity of messages and where a second group of messages among the multiple groups of messages includes a second multiplicity of messages. The first multiplicity of messages and the second multiplicity of messages differ. For example, one multiplicity of messages can be a subset of the other multiplicity of messages; they can have overlapping messages, one, or no overlapping messages. As a more specific example, the first group of messages can be an inbox, while the second group of messages can be the archive folder, a project folder, or any other folder created by the user or the system that groups messages. The messages can include email messages, text messages, instant messages, audio messages, video messages, and/or multimedia messages.

In step 410, the processor can determine a first visual indicator associated with the first group of messages and a second visual indicator associated with the second group of messages, where the first visual indicator and the second visual indicator differ. The first visual indicator can indicate membership in the first group of messages and the second visual indicator can indicate membership in the second group of messages. The first visual indicator and the second visual indicator can include, individually or in combination, a font style, a font size, a color, an image, and/or a symbol, e.g., stars or pound signs or an icon.

In step 420, the processor can apply the first visual indicator to the first group of messages and the second visual indicator to the second group of messages, thereby indicating to a user the grouping of the first multiplicity of messages and the second multiplicity of messages.

The processor can receive an indication to move a first message in the first group of messages to the second group of messages. For example, the processor can determine whether to move a first email message in the first group of email messages to the second group of email messages based on the passage of time or based on content of the email, as described in more detail in this application. Upon receiving the indication, the processor can move the first message in the first group of messages associated with the first visual indicator to the second group of messages. The processor can present the first message using the second visual indicator.

To determine the first visual indicator and the second visual indicator, the processor can obtain a hierarchy of messages, where the hierarchy of messages indicates a folder, such as a parent folder or a child folder. The processor can determine a first location of the first group of messages in a hierarchy of messages and a second location of the second group of messages in the hierarchy of messages. The first location can include a first parent folder and a first child folder indicating the first group, and the second location can include a second parent folder and a second child folder indicating the second group. The processor can create a third visual indicator associated with the first child folder and a fourth visual indicator associated with the first parent folder. The processor can create the fifth visual indicator associated with the second child folder and sixth visual indicator associated with the second parent folder. The processor can create the first visual indicator, e.g., a compound visual indicator, including the third visual indicator and the fourth visual indicator, thereby indicating the first location of the first group of messages in the hierarchy of messages. The processor can create the second visual indicator, also a compound visual indicator, including the fifth visual indicator and the sixth visual indicator, thereby indicating the second location of the second group of messages in the hierarchy of messages.

To determine whether to move a first message in the first group of messages to the second group of messages, the processor can use AI. Specifically, the processor can provide multiple messages to an artificial intelligence and a request to analyze content associated with the multiple messages to determine a grouping of the multiple messages. The processor can obtain an indication of the first group of messages. The processor can request a permission from a user to group the multiple messages into the first group of messages. The user can interact with the processor using augmented reality/virtual reality/mixed reality (AR/VR/XR) devices such as AR glasses, as further described in this application. Upon receiving the permission from the user, the processor can create the first group of messages.

The processor can obtain an indication to move the first group of messages to a second location in a hierarchy of messages, wherein the hierarchy of messages indicates one or more folders. The processor can determine a hierarchical visual indicator indicating the second location in the hierarchy of messages. The hierarchical visual indicator can be a compound indicator including all the indicators of the parent folders in the hierarchy. If the parent folder is color-coded, the representation of the color in the hierarchical visual indicator can be a colored circle. The processor can obtain the first visual indicator indicating the first group of messages, where the first visual indicator does not indicate the location in the hierarchy and is solely associated with the first group of messages. The processor can move the first group of messages to the second location in the hierarchy of messages. The processor can create a third visual indicator including the hierarchical visual indicator and the first visual indicator. The processor can present the third visual indicator along with the first group of messages and every message in the first group of messages.

The processor can use AI to suggest a symbol associated with the folder. Specifically, the processor can provide to the AI the first group of messages and a request to analyze content associated with the first group of messages to determine the first visual indicator. The processor can obtain an indication of the first visual indicator. The processor can request a permission from a user to present the first group of messages along with the first visual indicator. Upon receiving the permission from the user, the processor can present the first group of messages along with the first visual indicator. Further, every message in the first group of messages can be presented along with the first visual indicator.

To determine whether to move a first message in the first group of messages to the second group of messages, the processor can determine a time associated with receiving the first message. The processor can determine a time elapsed since the time associated with receiving the first message. The processor can determine whether the time elapsed since the time associated with receiving the first message is above a predetermined threshold, such as a year or a month. Upon determining that the time elapsed is above the predetermined threshold, the processor can automatically determine to move the first message to the second group of messages.

The processor can display the same message displayed differently depending on the folder that the message is in. The processor can determine a second message that is included in the first group of messages and in the second group of messages. The processor can present the second message in the first group of messages including the first visual indicator. The processor can present the second message in the second group of messages including the second visual indicator.

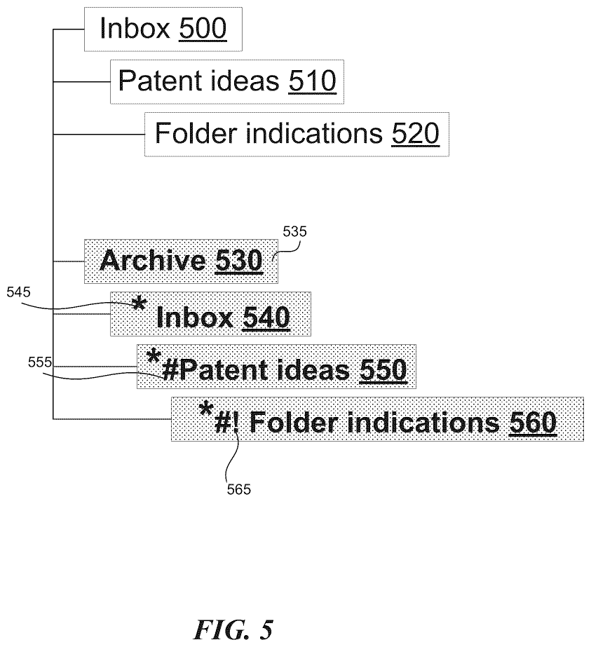

FIG. 5 shows multiple hierarchies 500, 540 of folders. “Inbox” folder 500 can be the grandfather folder, “Patent Ideas” folder 510 can be the parent folder, and “Folder Indications” folder 520 can be the grandchild folder. In another example, “Archive” folder 530 can be the grandfather folder, “Inbox” folder 540 can be the parent folder, “Patent Ideas” folder 550 can be the grandchild folder, and “Folder Indications” folder 560 can be a great-grandchild folder. Any given folder 500, 510, 520, 530, 540, 550, 560 can have its own visual indicator(s), however, the folder 500, 510, 520, 530, 540, 550, 560 can also automatically inherit all visual indicators 535, 545, 555, 565 for folders above it as follows. “Archive” folder 530 can be green 535, “Inbox” folder 540 can be green 535 and have an asterisk 545, “Patent Ideas” folder 550 can be green 535, have an asterisk 545, and have a hashtag 555, while “Folder Indications” folder 560 can be green 535, have an asterisk 545, have a hashtag 555, and have an exclamation point 565.

The system is not required to assign an indicator(s) 535, 545, 555, 565. For example, the system can skip assigning an indicator 535 for the “Archive” folder 530 and just assign an asterisk indicator 545 for the “Inbox” folder 540. The system can skip assigning an indicator 555 to the “Patent Ideas” folder 550 and then, for the “Folder Indications” folder 560, assign an asterisk indicator 545 and an exclamation point indicator 565.

The system can prompt the user to assign indicators 535, 545, 555, 565, and the user can choose to which folders to assign indicators. In the hierarchy rooted at folder 500, the user can choose not to place an indicator on the “Inbox” grandparent folder 500 but rather on the parent and grandchild folders 510, 520. In the hierarchy rooted at folder 530, the user can choose to assign indicator 535 to show when the user is working in the “Archive” folder 530 as opposed to in the “Inbox” folder 500.

If a user creates a favorites folder (a clone of a folder from the Inbox), the favorites folder can inherit the same visual indicator(s) or vice versa.

When new email arrives at the Inbox, the system, following the rules as described in this application, can file the email in a folder within the Inbox or another folder outside of the Inbox such as trash. The email can then inherit the same visual indicator(s), if any, as the folder the email was placed in.

As shown in FIGS. 2 and 3, when a given folder is open, its name is usually stated at the top of the disclosed email list. This name should inherit the same indicator(s) as the folder itself.

The system can copy and paste an email into another folder(s). If this occurs, the email can show the indicators from all folders in which the email is duplicated. If an email that is already filed in a folder is moved to a different folder, then the email can lose its current indicator(s) and inherit the indicator(s) of the new folder.

In all the above situations, the user can alter the default rules. For example, the user can indicate not to show the visual indicator(s) of the emails themselves, or not to automatically inherit the visual indicator from folders higher in the hierarchy.

The system can automatically indicate in a “Recent” folder (not shown) those folders that have the most recent activity and can rearrange the folders within the “Recent” folder based on the most recent activity. For example, the system can indicate the top five folders accessed the most over the past 24 or 48 hours. Emails often run in bunches, mostly because of what the user is working on. The system can also show the number of emails each folder contains.

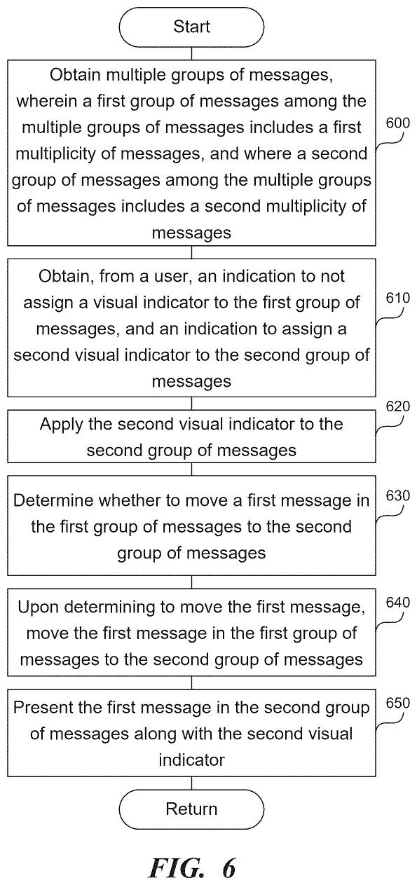

FIG. 6 is a flowchart of a method to create visual indicators representing folder membership of email messages, according to another embodiment. A hardware or software processor executing instructions described in this application can in step 600 obtain multiple groups of messages, where a first group of messages among the multiple groups of messages includes a first multiplicity of messages, and a second group of messages among the multiple groups of messages includes a second multiplicity of messages. The first multiplicity of messages and the second multiplicity of messages differ. For example, one multiplicity of messages can be a subset of the other multiplicity of messages; they can have multiple overlapping messages, one overlapping message, or no overlapping messages. As a more specific example, the first group of messages can be an inbox, while the second group of messages can be the archive folder, a project folder, or any other folder created by the user or the system that groups messages. The messages can include email messages, text messages, instant messages, audio messages, video messages, and/or multimedia messages.

In step 610, the processor can obtain, from a user, an indication to not assign a visual indicator to the first group of messages, and an indication to assign a second visual indicator to the second group of messages, where the second visual indicator indicates membership in the second group of messages. Consequently, the first group of messages can have no visual indicator. The processor can obtain the user input through an augmented reality system, a virtual reality system, or a mixed reality system.

In step 620, the processor can apply the second visual indicator to the second group of messages, thereby indicating to a user a grouping of the first multiplicity of messages and the second multiplicity of messages.

In step 630, the processor can determine whether to move a first message in the first group of messages to the second group of messages. In step 640, upon determining to move the first message, the processor can move the first message in the first group of messages to the second group of messages. In step 650, the processor can present the first message in the second group of messages along with the second visual indicator.

The processor can obtain an indication to duplicate a group of messages, such as to create a favorites folder. The processor can determine whether to duplicate the first group of messages or the second group of messages. Upon determining to duplicate the first group of messages, the processor can create a third group of messages without the visual indicator. Upon determining to duplicate the second group of messages, the processor can create the third group of messages including the second visual indicator.

The processor can obtain a hierarchy of messages, where the hierarchy of messages indicates a folder. The processor can determine a first location of the first group of messages in the hierarchy of messages, and a second location of the second group of messages in the hierarchy of messages, where the first location includes a first parent folder and a first child folder indicating the first group of messages, and the second location includes a second parent folder and a second child folder indicating the second group of messages. The processor can obtain a fourth visual indicator associated with the first parent folder. The processor can create a fifth visual indicator associated with the second child folder and a sixth visual indicator associated with the second parent folder. The processor can indicate the first location of the first group of messages in the hierarchy of messages by displaying the fourth visual indicator associated with the first group of messages. The processor can create the second visual indicator including the fifth visual indicator and the sixth visual indicator, thereby indicating the second location of the second group of messages in the hierarchy of messages.

The processor can obtain a hierarchy of messages, where the hierarchy of messages indicates a folder. The processor can determine a first location of the first group of messages in a hierarchy of messages, and a second location of the second group of messages in the hierarchy of messages, where the first location includes a first parent folder and a first child folder indicating the first group of messages, and the second location includes a second parent folder and a second child folder indicating the second group of messages. The processor can create a third visual indicator associated with the first child folder and a fourth visual indicator associated with the first parent folder. The processor can create a fifth visual indicator associated with the second child folder and a sixth visual indicator associated with the second parent folder. The processor can indicate the first location of the first group of messages in the hierarchy of messages by displaying the fourth visual indicator associated with the first group of messages. The processor can obtain an indication from a user to not include the fifth visual indicator in the second visual indicator. Upon obtaining the indication to not include the fifth visual indicator, the processor can create the second visual indicator including the sixth visual indicator, thereby indicating the second location of the second group of messages in the hierarchy of messages.

The processor can determine among the multiple groups of messages a subset of the multiple groups of messages that have been accessed most frequently within a predetermined amount of time, such as 24 hours or 48 hours. The processor can present the subset of the multiple groups of messages in a folder indicating recently accessed messages, e.g., a folder labeled “Recent,” and can rearrange the folders within the “Recent” folder based on the most recent activity. The folder can be updated every hour.

The processor can obtain an indication to move the first group of messages to a second location in a hierarchy of messages, where the hierarchy of messages indicates a folder. The processor can determine a hierarchical visual indicator indicating the second location in the hierarchy of messages, where the hierarchical visual indicator includes multiple visual indicators. The processor can move the first group of messages to the second location in the hierarchy of messages. The processor can receive an indication from a user to remove a first visual indicator among the multiple visual indicators from the hierarchical visual indicator. The processor can create a third visual indicator including the hierarchical visual indicator without the first visual indicator indicated by the user. The processor can present the third visual indicator along with the first group of messages.

The processor can determine a second message that is included in the first group of messages and in the second group of messages. The processor can present the second message in the first group of messages including the second visual indicator.

### Transformer for Neural Network

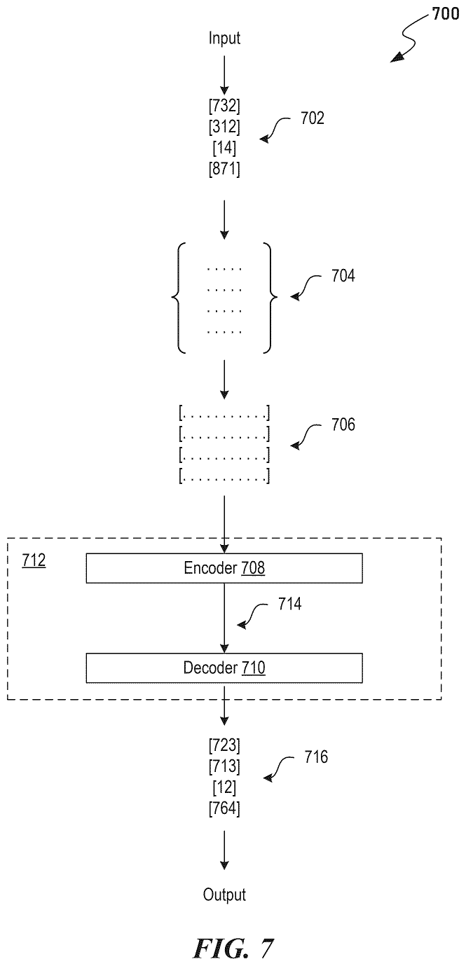

To assist in understanding the present disclosure, some concepts relevant to AI 700 in FIG. 7 including neural networks and machine learning (ML) are discussed herein. As described in this application, AI 700 can be used to analyze content of multiple messages to determine grouping of the multiple messages, and/or to suggest a visual indicator for the grouping of the multiple messages.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), generative adversarial networks (GANs), variational autoencoders (VAEs), and autoregressive models, among others.

DNNs are often used as ML-based models for modeling complex behaviors (e.g., human language, image recognition, object classification, etc.) in order to improve the accuracy of outputs (e.g., more accurate predictions), for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents, referred to as a “text corpus” (or simply referred to as a “corpus”). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus can be created by extracting text from online web pages and/or publicly available social media posts. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimizing a loss or maximizing a reward) in order to bring the output value as close to the target value as possible. The goal of training the ML model typically is to minimize a loss function or maximize a reward function.

The training data can be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performance-trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (e.g., update) the value of the parameters in the ML model with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture), unless stated otherwise. For example, unless stated otherwise, the “language model” encompasses large language models (LLMs).

A language model can use a neural network (typically a DNN) to perform natural language processing (NLP) tasks. A language model can be trained to model how words relate to each other in a textual sequence, based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistants).

A type of neural network architecture, referred to as a “transformer,” can be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as RNN-based language models.

FIG. 7 is a block diagram of an example transformer 712. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as RNN-based language models.

The transformer 712 includes an encoder 708 (which can include one or more encoder layers/blocks connected in series) and a decoder 710 (which can include one or more decoder layers/blocks connected in series). Generally, the encoder 708 and the decoder 710 each include multiple neural network layers, at least one of which can be a self-attention layer. The parameters of the neural network layers can be referred to as the parameters of the language model.

The transformer 712 can be trained to perform certain functions on a natural language input. Examples of the functions include summarizing existing content, brainstorming ideas, writing a rough draft, fixing spelling and grammar, and translating content. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 712 is trained to perform certain functions on other input formats than natural language input. For example, the input can include objects, images, audio content, or video content, or a combination thereof.

The transformer 712 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input).

FIG. 7 illustrates an example of how the transformer 712 can process textual input data. Input to a language model (whether transformer-based or otherwise) typically is in the form of natural language that can be parsed into tokens. The term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, and other tokens can provide formatting information, etc.

In FIG. 7, a short sequence of tokens 702 corresponding to the input text is illustrated as input to the transformer 712. Tokenization of the text sequence into the tokens 702 can be performed by some pre-processing tokenization module such as, for example, a byte-pair encoding tokenizer (the “pre” referring to the tokenization occurring prior to the processing of the tokenized input by the LLM), which is not shown in FIG. 7 for brevity. In general, the token sequence that is inputted to the transformer 712 can be of any length up to a maximum length defined based on the dimensions of the transformer 712. Each token 702 in the token sequence is converted into an embedding vector 706 (also referred to as “embedding 706”).

An embedding 706 is a learned numerical representation (such as, for example, a vector) of a token that captures some semantic meaning of the text segment represented by the token 702. The embedding 706 represents the text segment corresponding to the token 702 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 706 corresponding to the “write” token will be closer to another embedding corresponding to the “jot down” token in the vector space as compared to the distance between the embedding 706 corresponding to the “write” token and another embedding corresponding to the “summary” token.

The vector space can be defined by the dimensions and values of the embedding vectors. Various techniques can be used to convert a token 702 to an embedding 706. For example, another trained ML model can be used to convert the token 702 into an embedding 706. In particular, another trained ML model can be used to convert the token 702 into an embedding 706 in a way that encodes additional information into the embedding 706 (e.g., a trained ML model can encode positional information about the position of the token 702 in the text sequence into the embedding 706). In some implementations, the numerical value of the token 702 can be used to look up the corresponding embedding in an embedding matrix 704, which can be learned during training of the transformer 712.

The generated embeddings 706 are input into the encoder 708. The encoder 708 serves to encode the embeddings 706 into feature vectors 714 that represent the latent features of the embeddings 706. The encoder 708 can encode positional information (i.e., information about the sequence of the input) in the feature vectors 714. The feature vectors 714 can have very high dimensionality (e.g., on the order of thousands or tens of thousands), with each element in a feature vector 714 corresponding to a respective feature. The numerical weight of each element in a feature vector 714 represents the importance of the corresponding feature. The space of all possible feature vectors 714 that can be generated by the encoder 708 can be referred to as a latent space or feature space.

Conceptually, the decoder 710 is designed to map the features represented by the feature vectors 714 into meaningful output, which can depend on the task that was assigned to the transformer 712. For example, if the transformer 712 is used for a translation task, the decoder 710 can map the feature vectors 714 into text output in a target language different from the language of the original tokens 702. Generally, in a generative language model, the decoder 710 serves to decode the feature vectors 714 into a sequence of tokens. The decoder 710 can generate output tokens 716 one by one. Each output token 716 can be fed back as input to the decoder 710 in order to generate the next output token 716. By feeding back the generated output and applying self-attention, the decoder 710 can generate a sequence of output tokens 716 that has sequential meaning (e.g., the resulting output text sequence is understandable as a sentence and obeys grammatical rules). The decoder 710 can generate output tokens 716 until a special [EOT] token (indicating the end of the text) is generated. The resulting sequence of output tokens 716 can then be converted to a text sequence in post-processing. For example, each output token 716 can be an integer number that corresponds to a vocabulary index. By looking up the text segment using the vocabulary index, the text segment corresponding to each output token 716 can be retrieved, the text segments can be concatenated together, and the final output text sequence can be obtained.

In some implementations, the input provided to the transformer 712 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to the question, text associated with the request, or a list of ideas associated with the request. For example, the input can include the question “What is the weather like in San Francisco?” and the output can include a description of the weather in San Francisco. As another example, the input can include a request to brainstorm names for a flower shop and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use autoregression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Computer System

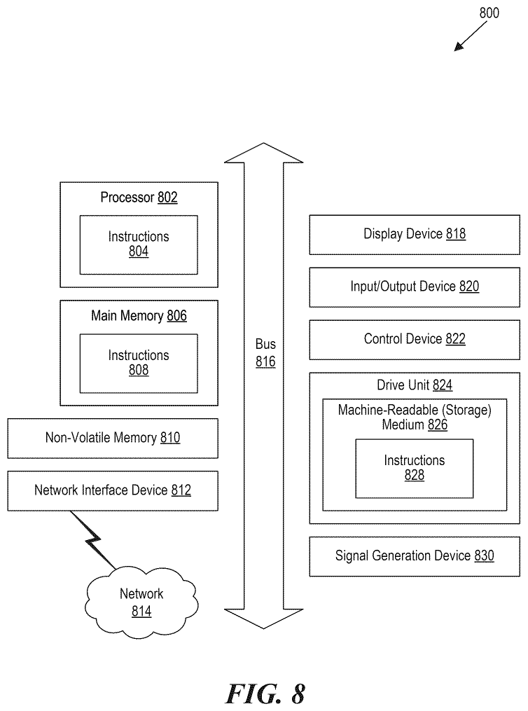

FIG. 8 is a block diagram that illustrates an example of a computer system 800 in which at least some operations described herein can be implemented. As shown, the computer system 800 can include: one or more processors 802, main memory 806, non-volatile memory 810, a network interface device 812, a video display device 818, an input/output device 820, a control device 822 (e.g., keyboard and pointing device), a drive unit 824 that includes a machine-readable (storage) medium 826, and a signal generation device 830 that are communicatively connected to a bus 816. The bus 816 represents one or more physical buses and/or point-to-point connections that are connected by appropriate bridges, adapters, or controllers. Various common components (e.g., cache memory) are omitted from FIG. 8 for brevity. Instead, the computer system 800 is intended to illustrate a hardware device on which components illustrated or described relative to the examples of the Figures and any other components described in this specification can be implemented.

The computer system 800 can take any suitable physical form. For example, the computing system 800 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 800. In some implementations, the computer system 800 can be an embedded computer system, a system-on-chip (SOC), a single-board computer system (SBC), or a distributed system such as a mesh of computer systems, or it can include one or more cloud components in one or more networks. Where appropriate, one or more computer systems 800 can perform operations in real time, in near real time, or in batch mode.

The network interface device 812 enables the computing system 800 to mediate data in a network 814 with an entity that is external to the computing system 800 through any communication protocol supported by the computing system 800 and the external entity. Examples of the network interface device 812 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 806, non-volatile memory 810, machine-readable medium 826) can be local, remote, or distributed. Although shown as a single medium, the machine-readable medium 826 can include multiple media (e.g., a centralized/distributed database and/or associated caches and servers) that store one or more sets of instructions 828. The machine-readable medium 826 can include any medium that is capable of storing, encoding, or carrying a set of instructions for execution by the computing system 800. The machine-readable medium 826 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 810, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 804, 808, 828) set at various times in various memory and storage devices in computing device(s). When read and executed by the processor 802, the instruction(s) cause the computing system 800 to perform operations to execute elements involving the various aspects of the disclosure.

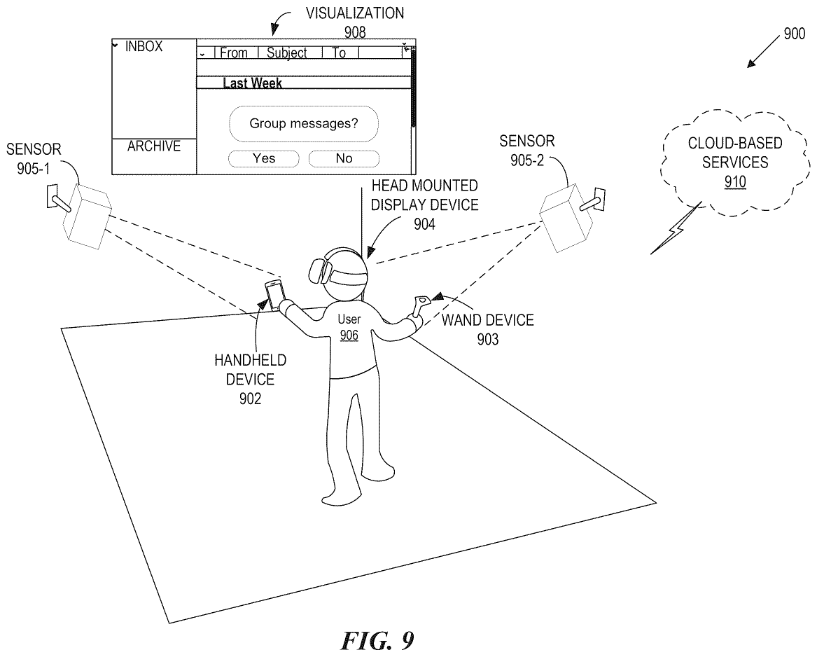

FIG. 9 illustrates a user engaged with a mixed reality system 900 for immersive message management. The components of the system 900 can include a handheld device 902 that administers a session running on other components of the system 900 including a head-mounted display (HMD) device 904 that renders a partial or full 860-degree interface. The system 900 can also include motion or position sensors 905-1 and 905-2, which are fixed in a room or worn by the user 906 such as, for example, sensors of wearables. The HMD device 904 can be an AR/VR/XR device. In some embodiments the HMD device 904 can include glasses.

A near-eye display device, commonly referred to as an HMD device, is an optical apparatus designed to present visual information directly in front of the user's eyes. This technology is composed of several integral components that work in unison to deliver a seamless and immersive visual experience.

Central to the near-eye display device lies the optical module. The optical module includes lenses and other optical elements that project images from a microdisplay or similar image source directly into the user's eyes. The optical module is engineered to ensure that the images are clear, focused, and appear at a comfortable viewing distance, thereby enhancing the overall user experience.

The microdisplay is a small yet high-resolution display panel responsible for generating the visual content. Utilizing technologies such as Liquid Crystal Display (LCD), Organic Light Emitting Diode (OLED), Liquid Crystal on Silicon (LCoS), or Digital Light Processing (DLP), the microdisplay renders the images or video content that the user perceives.

Supporting these components is the frame and housing, which provides the structural integrity needed to hold the optical module and microdisplay in place. Designed to be lightweight and comfortable for extended wear, the frame often includes adjustable straps or other mechanisms to ensure a secure and personalized fit on the user's head.

Modern near-eye display devices are equipped with an array of sensors, including accelerometers, gyroscopes, magnetometers, and eye-tracking sensors. These sensors enable head tracking, motion detection, and gaze tracking, significantly enhancing the interactivity and immersive nature of the device. The data collected by these sensors is processed by a built-in or connected processing unit, which handles the computation required for rendering images, processing sensor data, and managing user inputs. This processing unit may be integrated into the device or connected via a wired or wireless link to an external computer or mobile device.

Connectivity interfaces such as USB, HDMI, Bluetooth, or Wi-Fi are also integral to the device, allowing it to interface with external devices, transfer data, or receive content. The power supply, typically a battery or power management system, provides the necessary energy to operate the device efficiently, supporting extended usage without frequent recharging.

User interaction with the near-eye display device is facilitated through various user interface options, including physical buttons, touchpads, voice control, or gesture recognition systems. Additionally, some devices feature integrated speakers or headphone jacks to provide audio output, further enhancing the multimedia experience.

As illustrated, the handheld device 902 operates as a wand to navigate objects of the visualization 908 experienced by the user 906 through the HMD device 904. A dedicated wand device 903 (e.g., with one or more dedicated hardware buttons) can additionally or alternatively be used for navigation. In another example, the sensors 905-1 and 905-2 can detect the position and/or movement of the user's finger in the air to perform the functions including the examples illustrated in FIGS. 1 through 4, which could be rendered in a mixed reality session, e.g., on the handheld device 902. For example, the queries regarding grouping of messages, or the queries regarding visualizations of group messages can be presented to the user 906 through the visualization 908.

In some embodiments, some components of the system 900 are remotely located from the user. For example, cloud components can provide cloud-based services 910 to administer the mixed reality session running on the components of the system 900 or provide services or content for a mixed reality session. Hence, administration of a mixed reality session could be through the HMD device 904, augmented with the handheld device 902, and/or with the cloud-based services 910 that receives session progress feedback (e.g., anywhere outside of a room where the user is experiencing a simulation).

As shown, the HMD device 904 can provide content (e.g., visualization 908) of a mixed reality session and process feedback from the user via the handheld device 902 to navigate the visualization 908. As shown, the HMD device 904 is a near-to-eye display system that is worn by the user 906. For example, the HMD device 904 can have a chassis and various electrical and optical components to enable an immersive experience by the user 906 wearing the HMD device 904. For example, the HMD device 904 can include a display for each of the user's eyes. The displays can render a real-world scene of a simulation for view by the user's eyes when the HMD device 904 is worn by the user. The HMD device 904 can also include a camera mounted to the chassis. The camera can capture movement of the user's pupils for physiological feedback responsive to simulated scenes being rendered. The HMD device 904 may also include a network interface enabling the handheld device 902 to communicatively couple to the HMD device 904 over a wireless connection.

In some embodiments, the HMD device 904 includes features for measuring the user's physiological activity. For example, the HMD device 904 can include components to measure the user's electrical brain activity. As such, the HMD device 904 can collect physiological data in combination with any direct input by the user. In some embodiments, the physiological data can be used to supplement the user's conscious inputs. In some embodiments, the physiological data could be used to compare against the user's conscious input.

In one example, the HMD device 904 can render a virtual immersive environment by displaying images in view of the user's eyes such that the user can only see the images (e.g., visualization 908) and see nothing of the real-world. The HMD device 904 can also render an AR environment. As such, the user can see the visualization 908 overlaying the real world while the HMD device 904 is worn by the user 906. Hence, to achieve an AR environment, the user in an augmented reality simulation has a transparent view with digital objects overlaid or superimposed on the user's real-world view.

Examples of the sensors 905-1 and 905-2 include cameras or motion detectors that are positioned proximate to the user such that the sensors 905-1 and 905-2 can obtain real-world feedback responsive to interactions with a simulated real-world scene. For example, cameras facing the user can detect the user 706's movement while the user is engaged in a simulation and provide feedback to the HMD device 904 administering the simulation. The handheld device 902 can be used by the user 906 to submit input, which can include actuating buttons for the user 906 to input data and/or accelerometers that detect spatial movement. For example, the user 906 can move the handheld device 902 to provide inputs responsive to a scene administered by the HMD device 904.

The visualization 908 is one example of many that can be rendered in a mixed reality session. FIGS. 1-4 show examples of visualizations that could likewise be rendered in a mixed reality session. The user 906 can select and move objects of the visualization 908 in a manner described with respect to FIGS. 1-4. As described further below, the system 900 can include servers that are remotely located from the user 906 and can access a program administered by the HMD device 904. Further, a local software generation and distribution framework can be used to rapidly scale content. The core components and services can support complex user and session elements that can be easily managed by a service provider. As such, a platform of a mixed reality system can standardize interaction elements such as a session landing, sign-in, navigation rules, and the like. A top-level abstraction layer can support customization such as a sequence of sessions or scenes or conditional ordering of sessions or scenes. Services can include authentication, tracking, reports, user services, help services, pause and resume services, and the like.

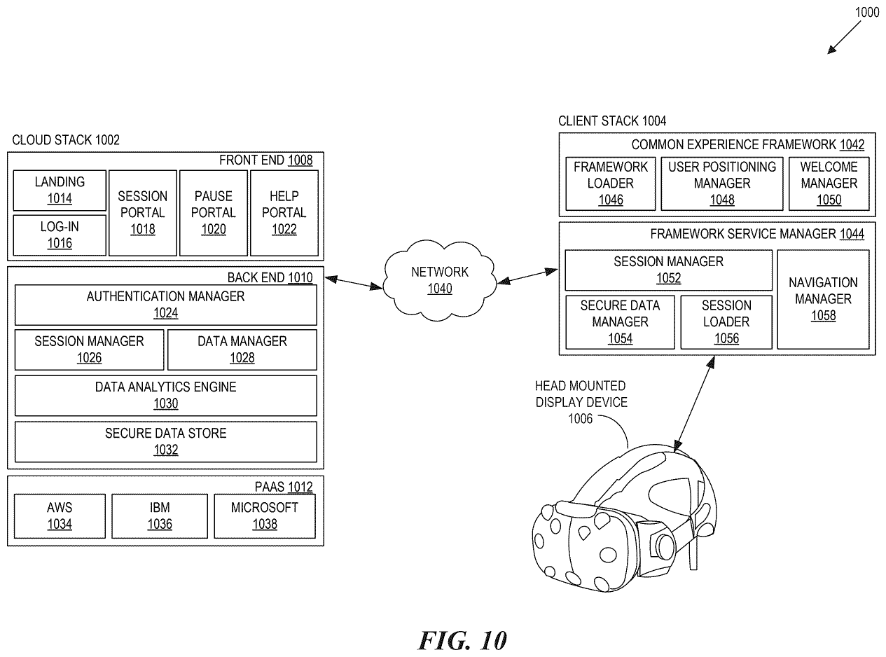

FIG. 10 is a block diagram illustrating a cloud stack 1002 and a client stack 1004 architecture for a platform 1000 that can collectively administer a mixed reality session on an HMD device 1006. As shown, the cloud stack 1002 includes three primary layers: a front end layer 1008, a back end layer 1010, and a platform as a service (PaaS) layer 1012. The front end layer 1008 includes a landing component 1014 and a login component 1016. The two components 1014 and 1016 are executed at the beginning of a session administered to orient a user and seek login credentials to control access to message programs and user information of the platform 1000. The front end layer 1008 also includes a session portal 1018, pause portal 1020, and help portal 1022. The session portal 1018 is for normal front-facing operations of a simulation session whereas the pause portal 1020 is for operations while the session is paused. Lastly, the help portal 1022 can help the user or administrator to address questions related to the platform 1000 or simulation.

The back end layer 1010 includes an authentication manager 1024 that can authenticate a user and/or an administrator of the platform 1000. A session manager 1026 can manage access to a particular session. A data manager 1028 can manage user data and/or data about the session such as any feedback from users while engaged in sessions. For example, the data manager 1028 can collect feedback data from multiple users including their inputs and physiological data. A data analytics engine 1030 can process the collected data to determine the actions of users and to learn how to improve the sessions (e.g., mixed reality scenes). A secure data store 1032 can store sensitive data such as data that identifies users. Lastly, the PaaS layer 1012 includes cloud computing services that provide the platform 1000 for clients to administer the mixed reality sessions. Examples include AMAZON WEB SERVICES (AWS) 1034, or services provided by IBM 1036 and/or MICROSOFT 1038.

The cloud stack 1002 is communicatively connected to the client stack 1004 over a network 1040 such as the internet. The client stack 1004 includes a common experience framework layer 1042 and a framework service manager layer 1044. The common experience framework layer 1042 includes a framework loader 1046 to load the framework for a session, a user positioning manager 1048 to monitor and track the relative position of the user engaged with the session, and a welcome manager 1050 to orient the user at the beginning of the session. s

The framework service manager layer 1044 includes a session manager 1052 to manage the session experienced by a user wearing the HMD device 1006. The framework service manager layer 1044 also includes a secure data manager 1054 to store or anonymize any sensitive data, session load manager 1056 for loading a session, and a navigation manager 1058 for navigating a user through mixed reality scenes of a message management program. The platform 1000 is merely illustrative to aid the reader in understanding an embodiment. Other embodiments may include fewer or additional layers/components known to persons skilled in the art but omitted for brevity.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above and any that may be listed in accompanying filing papers are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A non-transitory, computer-readable storage medium comprising instructions recorded thereon, wherein the instructions, when executed by at least one data processor of a system, cause the system to:
obtain multiple groups of email messages,
wherein a first group of email messages among the multiple groups of email messages includes a first multiplicity of email messages,
wherein a second group of email messages among the multiple groups of email messages includes a second multiplicity of email messages, and
wherein the first multiplicity of email messages and the second multiplicity of email messages differ;
obtain, from a user, an indication to not assign a visual indicator to the first group of email messages, and an indication to assign a second visual indicator to the second group of email messages,
wherein the second visual indicator indicates membership in the second group of email messages;
apply the second visual indicator to the second group of email messages, thereby indicating to a user a grouping of the first multiplicity of email messages and the second multiplicity of email messages;
determine whether to move a first email message in the first group of email messages
to the second group of email messages;
upon determining to move the first email message, move the first email message in the first group of email messages to the second group of email messages; and
present the first email message in the second group of email messages along with the second visual indicator.

2. The non-transitory, computer-readable storage medium of claim 1, comprising instructions to:
obtain an indication to duplicate a group of email messages;
determine whether to duplicate the first group of email messages or the second group of email messages;
upon determining to duplicate the first group of email messages, create a third group of email messages without the visual indicator; and
upon determining to duplicate the second group of email messages, create the third group of email messages including the second visual indicator.

3. The non-transitory, computer-readable storage medium of claim 1, comprising instructions to:
obtain a hierarchy of email messages,
wherein the hierarchy of email messages indicates a folder;
determine a first location of the first group of email messages in the hierarchy of email messages, and a second location of the second group of email messages in the hierarchy of email messages,
wherein the first location includes a first parent folder and a first child folder indicating the first group of email messages, and the second location includes a second parent folder and a second child folder indicating the second group of email messages;
obtain a fourth visual indicator associated with the first parent folder;
create a fifth visual indicator associated with the second child folder and a sixth visual indicator associated with the second parent folder;
indicate the first location of the first group of email messages in the hierarchy of email
messages by displaying the fourth visual indicator associated with the first group of email messages; and
create the second visual indicator including the fifth visual indicator and the sixth visual indicator, thereby indicating the second location of the second group of email messages in the hierarchy of email messages.

4. The non-transitory, computer-readable storage medium of claim 1, comprising instructions to:
obtain a hierarchy of email messages,
wherein the hierarchy of email messages indicates a folder;
determine a first location of the first group of email messages in the hierarchy of email messages, and a second location of the second group of email messages in the hierarchy of email messages,
wherein the first location includes a first parent folder and a first child folder indicating the first group of email messages, and the second location includes a second parent folder and a second child folder indicating the second group of email messages;
create a third visual indicator associated with the first child folder and a fourth visual indicator associated with the first parent folder;
create a fifth visual indicator associated with the second child folder and a sixth visual indicator associated with the second parent folder;
indicate the first location of the first group of email messages in the hierarchy of email messages by displaying the fourth visual indicator associated with the first group of email messages;
obtain an indication from a user to not include the fifth visual indicator in the second visual indicator; and
upon obtaining the indication to not include the fifth visual indicator, create the second visual indicator including the sixth visual indicator, thereby indicating the second location of the second group of email messages in the hierarchy of email messages.

5. The non-transitory, computer-readable storage medium of claim 1, comprising instructions to:
determine among the multiple groups of email messages a subset of the multiple groups of email messages that have been accessed most frequently within a predetermined amount of time; and
present the subset of the multiple groups of email messages in a folder indicating recently accessed email messages.

6. The non-transitory, computer-readable storage medium of claim 1, comprising instructions to:
obtain an indication to move the first group of email messages to a second location in a hierarchy of email messages,
wherein the hierarchy of email messages indicates a folder;
determine a hierarchical visual indicator indicating the second location in the hierarchy of email messages,
wherein the hierarchical visual indicator includes multiple visual indicators;
move the first group of email messages to the second location in the hierarchy of email messages;
receive an indication from a user to remove a first visual indicator among the multiple visual indicators from the hierarchical visual indicator;
create a third visual indicator including the hierarchical visual indicator without the first visual indicator indicated by the user; and
present the third visual indicator along with the first group of email messages.

7. The non-transitory, computer-readable storage medium of claim 1, comprising instructions to:
determine a second email message that is included in the first group of email messages and in the second group of email messages; and
present the second email message in the first group of email messages including the second visual indicator.

8. The non-transitory, computer-readable storage medium of claim 1, comprising instructions to obtain, from the user, the indication using an augmented reality system, a virtual reality system, or a mixed reality system.

9. A method comprising:
obtaining multiple groups of messages,
wherein a first group of messages among the multiple groups of messages includes a first multiplicity of messages,
wherein a second group of messages among the multiple groups of messages includes a second multiplicity of messages, and
wherein the first multiplicity of messages and the second multiplicity of messages differ;
obtaining, from a user, an indication to not assign a visual indicator to the first group of messages, and an indication to assign a second visual indicator to the second group of messages,
wherein the second visual indicator indicates membership in the second group of messages;
applying the second visual indicator to the second group of messages, thereby indicating to a user a grouping of the first multiplicity of messages and the second multiplicity of messages;
determining whether to move a first message in the first group of messages to the second group of messages;
upon determining to move the first message, moving the first message in the first group of messages to the second group of messages; and
presenting the first message in the second group of messages along with the second visual indicator.

10. The method of claim 9, comprising:
obtaining an indication to duplicate a group of messages;
determining whether to duplicate the first group of messages or the second group of messages;
upon determining to duplicate the first group of messages, creating a third group of messages without the visual indicator; and
upon determining to duplicate the second group of messages, creating the third group of messages including the second visual indicator.

11. The method of claim 9, comprising:
obtaining a hierarchy of messages,
wherein the hierarchy of messages indicates a folder;
determining a first location of the first group of messages in the hierarchy of messages, and a second location of the second group of messages in the hierarchy of messages,
wherein the first location includes a first parent folder and a first child folder indicating the first group of messages, and the second location includes a second parent folder and a second child folder indicating the second group of messages;
obtaining a fourth visual indicator associated with the first parent folder;
creating a fifth visual indicator associated with the second child folder and a sixth visual indicator associated with the second parent folder;
indicating the first location of the first group of messages in the hierarchy of messages by displaying the fourth visual indicator associated with the first group of messages; and
creating the second visual indicator including the fifth visual indicator and the sixth visual indicator, thereby indicating the second location of the second group of messages in the hierarchy of messages.

12. The method of claim 9, comprising:
obtaining a hierarchy of messages,
wherein the hierarchy of messages indicates a folder;
determining a first location of the first group of messages in the hierarchy of messages, and a second location of the second group of messages in the hierarchy of messages,
wherein the first location includes a first parent folder and a first child folder indicating the first group of messages, and the second location includes a second parent folder and a second child folder indicating the second group of messages;
creating a third visual indicator associated with the first child folder and a fourth visual indicator associated with the first parent folder;
creating a fifth visual indicator associated with the second child folder and a sixth visual indicator associated with the second parent folder;
indicating the first location of the first group of messages in the hierarchy of messages by displaying the fourth visual indicator associated with the first group of messages;
obtaining an indication from a user to not include the fifth visual indicator in the second visual indicator; and
upon obtaining the indication to not include the fifth visual indicator, creating the second visual indicator including the sixth visual indicator, thereby indicating the second location of the second group of messages in the hierarchy of messages.

13. The method of claim 9, comprising:
determining among the multiple groups of messages a subset of the multiple groups of messages that have been accessed most frequently within a predetermined amount of time; and
presenting the subset of the multiple groups of messages in a folder indicating recently accessed messages.

14. The method of claim 9, comprising:
obtaining an indication to move the first group of messages to a second location in a hierarchy of messages,
wherein the hierarchy of messages indicates a folder;
determining a hierarchical visual indicator indicating the second location in the hierarchy of messages,
wherein the hierarchical visual indicator includes multiple visual indicators;
moving the first group of messages to the second location in the hierarchy of messages;
receiving an indication from a user to remove a first visual indicator among the multiple visual indicators from the hierarchical visual indicator;
creating a third visual indicator including the hierarchical visual indicator without the first visual indicator indicated by the user; and
presenting the third visual indicator along with the first group of messages.

15. The method of claim 9, comprising:
determining a second message that is included in the first group of messages and in the second group of messages; and
presenting the second message in the first group of messages including the second visual indicator.

16. The method of claim 9, comprising obtaining, from the user, the indication using an augmented reality system, a virtual reality system, or a mixed reality system.

17. A system comprising:
at least one hardware processor; and
at least one non-transitory memory storing instructions, which, when executed by the at least one hardware processor, cause the system to:
obtain multiple groups of messages,
wherein a first group of messages among the multiple groups of messages includes a first multiplicity of messages,
wherein a second group of messages among the multiple groups of messages includes a second multiplicity of messages, and
wherein the first multiplicity of messages and the second multiplicity of messages differ;
obtain, from a user, an indication to not assign a visual indicator to the first group of messages, and an indication to assign a second visual indicator to the second group of messages,
wherein the second visual indicator indicates membership in the second group of messages;
apply the second visual indicator to the second group of messages, thereby indicating to a user a grouping of the first multiplicity of messages and the second multiplicity of messages;
determine whether to move a first message in the first group of messages to the second group of messages;
upon determining to move the first message, move the first message in the first group of messages to the second group of messages; and
present the first message in the second group of messages along with the second visual indicator.

18. The system of claim 17, comprising instructions to:
obtain an indication to duplicate a group of messages;
determine whether to duplicate the first group of messages or the second group of messages;
upon determining to duplicate the first group of messages, create a third group of messages without the visual indicator; and
upon determining to duplicate the second group of messages, create the third group of messages including the second visual indicator.

19. The system of claim 17, comprising instructions to:
obtain a hierarchy of messages,
wherein the hierarchy of messages indicates a folder;
determine a first location of the first group of messages in the hierarchy of messages, and a second location of the second group of messages in the hierarchy of messages,
wherein the first location includes a first parent folder and a first child folder indicating the first group of messages, and the second location includes a second parent folder and a second child folder indicating the second group of messages;
obtain a fourth visual indicator associated with the first parent folder;
create a fifth visual indicator associated with the second child folder and a sixth visual indicator associated with the second parent folder;
indicate the first location of the first group of messages in the hierarchy of messages by displaying the fourth visual indicator associated with the first group of messages; and
create the second visual indicator including the fifth visual indicator and the sixth visual indicator, thereby indicating the second location of the second group of messages in the hierarchy of messages.

20. The system of claim 17, comprising instructions to:
obtain a hierarchy of messages,
wherein the hierarchy of messages indicates a folder;
determine a first location of the first group of messages in the hierarchy of messages, and a second location of the second group of messages in the hierarchy of messages,
wherein the first location includes a first parent folder and a first child folder indicating the first group of messages, and the second location includes a second parent folder and a second child folder indicating the second group of messages;
create a third visual indicator associated with the first child folder and a fourth visual indicator associated with the first parent folder;
create a fifth visual indicator associated with the second child folder and a sixth visual indicator associated with the second parent folder;
indicate the first location of the first group of messages in the hierarchy of messages by displaying the fourth visual indicator associated with the first group of messages;
obtain an indication from a user to not include the fifth visual indicator in the second visual indicator; and
upon obtaining the indication to not include the fifth visual indicator, create the second visual indicator including the sixth visual indicator, thereby indicating the second location of the second group of messages in the hierarchy of messages.

21. The system of claim 17, comprising instructions to:
determine among the multiple groups of messages a subset of the multiple groups of messages that have been accessed most frequently within a predetermined amount of time; and
present the subset of the multiple groups of messages in a folder indicating recently accessed messages.

22. The system of claim 17, comprising instructions to:
obtain an indication to move the first group of messages to a second location in a hierarchy of messages,
wherein the hierarchy of messages indicates a folder;
determine a hierarchical visual indicator indicating the second location in the hierarchy of messages,
wherein the hierarchical visual indicator includes multiple visual indicators;
move the first group of messages to the second location in the hierarchy of messages;
receive an indication from a user to remove a first visual indicator among the multiple visual indicators from the hierarchical visual indicator;
create a third visual indicator including the hierarchical visual indicator without the first visual indicator indicated by the user; and
present the third visual indicator along with the first group of messages.

23. The system of claim 17, comprising instructions to:
determine a second message that is included in the first group of messages and in the second group of messages; and
present the second message in the first group of messages including the second visual indicator.

24. The system of claim 17, comprising instructions to obtain, from the user, the indication using an augmented reality system, a virtual reality system, or a mixed reality system.
